(19) United States
(12) Patent Application Publication
(10) Pub. No.: US 2024/0181489 A1
(43) Pub. Date: Jun. 6, 2024

(54) AN APPARATUS FOR WORKING A WET COATING ON A SURFACE AND A METHOD OF THE SAME

(71) Applicant: Q-BOT LIMITED, Wandsworth (GB)

(72) Inventors: Elodie Soler, London (GB); Mathew Holloway, London (GB); Chris Hamblin, London (GB); Joshua Kiff, London (GB); Tom Jolly, London (GB); Ashley Napier, Cockermouth (GB); Shubham Wagh, Oxford (IN)

(73) Assignee: Q-BOT LIMITED, Wandsworth (GB)

(21) Appl. No.: 18/284,729

(22) PCT Filed: Mar. 25, 2022
(86) PCT No.: PCT/GB2022/050751

§ 371 Date: Sep. 28, 2023

(30) Foreign Application Priority Data
Mar. 29, 2021 (GB) 2104418.5

(51) Int. Cl. B05C 11/04

(52) U.S. Cl. CPC B05C 11/041; B05C 11/044; B05C 11/048

(57) ABSTRACT

An apparatus for working a wet coating, such as render material, applied to a surface, the apparatus comprising: an actuator arranged to move an arm across a surface having a wet coating applied thereon; a controller configured to move the arm across the surface along a tool path; and a tool head mounted to the arm, the tool head comprising a compliance module and a tool mounted to the compliance module such that the tool is movable in a stroke direction towards the surface relative to the arm. The compliance module comprises a biasing module arranged to urge the tool in the stroke direction to maintain contact between the tool and the wet coating such that the tool works the wet coating as the arm moves across the surface.

This invention relates to an apparatus for working a wet coating, such as render material, on a surface, and a method of working a wet coating on a surface.

### BACKGROUND

Building works often involve a number of manual processes that require considerable time and expertise on the part of the individual builder to be completed to the desired standard. For example, a builder rendering a building will rely on both visual and haptic feedback as they apply and press the render layers against the wall with the correct pressure to ensure the render is applied correctly. Poor application of the render can result in the formation of lumps, cracks or marks, which can affect both the aesthetics and the technical performance of the material applied to the building. Render and insulation material are just two examples of wet materials that are applied to a building. Even in an off-site setting, which may have fewer variables to consider when applying the wet coating, manual processes are still necessary in at least some of the steps in preparing pre-fabricated building surfaces, such as walls and floors, or the application of brick slips and finishes to the facade.

Automation of these processes is possible, for example using sensor data from a LIDAR or depth camera to scan a building to generate a surface map which can be used to automate a robot to apply render. Such sensors typically have an accuracy of +/−5 mm to +/−25 mm. However, a building with substantially flat walls will typically have a surface variation greater than the accuracy of such sensors. For example, a +/−1% variation in a 6 m wide wall, will result in variations of +/−6 cm across its width and an uneven surface to work on. Errors in the surface map combined with variability in the building itself result in an uneven wet layer being applied to the building using existing automated devices. This is detrimental to both the aesthetics and performance of the building, for example impacting the thermal properties, structural integrity or weather proofing of the wall.

### BRIEF SUMMARY OF THE DISCLOSURE

Viewed from a first aspect, the present invention provides an apparatus for working a wet coating, such as render material, applied to a surface, the apparatus comprising:
an actuator arranged to move an arm across a surface having a wet coating applied thereon;
a controller configured to move the arm across the surface along a tool path; and
a tool head mounted to the arm, the tool head comprising a compliance module and a tool mounted to the compliance module such that the tool is movable in a stroke direction towards the surface relative to the arm, and wherein the compliance module comprises a biasing module arranged to urge the tool in the stroke direction to maintain contact with the wet coating to work the wet coating as the arm moves across the surface.

The apparatus may be a surface coating apparatus, for example a rendering apparatus.

Thus, the present invention provides an apparatus which can be easily positioned around a building and can operate a tool head over a surface of the building while the movement of the tool relative to the wet coating can ensure that the tool remains in contact with the wet coating despite variations in the control routines, wet coating and surface.

The stroke direction may be perpendicular to the surface, or it may be angled relative to the surface. The stroke direction may be parallel to a reaction force between the surface and the tool. For example, the reaction force may be a resultant force vector of a force normal to the surface and a frictional force between the tool and the surface as the tool moves.

In examples, the apparatus may comprise a sensor configured to detect a parameter that varies according to a distance between the arm and the wet coating in the stroke direction. The detected parameter may be a force, a position, a displacement, or a power current of the actuator, as described below.

For example, the sensor may be configured to measure a displacement of the tool relative to the tool head in the stroke direction. The sensor may be a displacement sensor arranged to measure a position of the tool relative to the tool head. In other examples, the sensor may be a force sensor, for example a load cell, arranged to detect the biasing force applied to the tool by the biasing module.

In examples, the sensor may alternatively or additionally be configured to detect a force applied by the actuator when moving the arm across the surface. For example, the sensor may be configured to detect a power current of the actuator. The power current of the actuator may increase or decrease according to the degree of interaction between the tool and the wet coating, so the power current of the actuator is indicative of the position of the tool relative to the wet coating. That is, if the tool is closer to the surface then it will be moving more wet coating as the arm moves, and the actuator moving the arm will have a higher power current.

In some examples, the tool head may comprise a motor arranged to rotate the tool in contact with the wet coating. In such examples, the sensor may comprise a torque sensor configured to measure a power current of the motor and/or a torque applied by the motor. A higher power current or torque may be indicative of a greater contact force between the wet coating and the tool.

In examples, the biasing module comprises a spring. The spring is arranged to urge the tool in the stroke direction, i.e., towards the surface. The spring may be a compression spring. The biasing module may additionally comprise a damper.

In examples, the controller may be configured to adjust the tool path based on the detected parameter as the arm moves across the surface. For example, if the detected parameter indicates that the tool is encountering high resistance in a particular area, the tool path may be configured to avoid that area.

In examples, the apparatus may further comprise a second actuator arranged to move the arm towards or away from the surface. The controller may be configured to control the second actuator based on the detected parameter. That is, the controller may be configured to move the tool closer to or further from the surface by the second actuator based on the detected parameter. This advantageously increases the amount of variability the apparatus can cope with, as larger variations in the surface can be detected by the sensor and the tool head position adjusted accordingly to account for this.

In examples, the tool head may comprise a tool actuator arranged to move the compliance module in the stroke direction. Moving the compliance module also moves the tool in the stroke direction. The controller may be configured to control the tool actuator based on the detected parameter. That is, the controller may be configured to move the tool closer to or further from the surface by the tool actuator based on the detected parameter. This advantageously increases the amount of variability the apparatus can cope with, as larger variations in the surface can be detected by the sensor and the tool head position adjusted accordingly to account for this.

In examples, the biasing module has an adjustable stiffness. The stiffness may be manually adjusted. Different stiffnesses may be provided for different wet coating materials and/or different desired finishes. A higher stiffness may correspond to a smoother finish of the wet coating.

In examples, the adjustable stiffness biasing module has an actuator to control the stiffness, and the controller may be configured to adjust the stiffness of the biasing module based on the detected parameter.

In examples, the controller may be configured to move the tool across the surface while maintaining a predetermined force between the tool and the wet coating based on the detected parameter. The predetermined force may be a range of forces.

In examples, the tool may comprise a scraper or a trowel. In examples, the tool is changeable. The compliance module may comprise a connector for connecting the tool to the compliance module. The tool may be disconnectable from the connector. A plurality of different tools may be connectable to the connector.

In examples, the controller is configured to position the tool in a substantially perpendicular orientation relative to the surface as the arm moves across the surface.

In examples, the apparatus may further comprise a rotary actuator arranged to rotate the compliance module and tool relative to the arm about a first axis perpendicular to the stroke direction. In further examples, the apparatus may comprise a second rotary actuator arranged to rotate the compliance module and tool relative to the arm about a second axis parallel to the stroke direction. This advantageously allows the apparatus to be used with non-planar, arcuate or irregular surface contours (e.g. bay windows, corners or around openings in the surface).

Viewed from a further aspect, the present invention provides a method of working a wet coating, such as render material, on a surface, the method comprising:
locating the apparatus described above adjacent a surface having a wet coating applied thereon, and
moving the tool head across the surface along a tool path while maintaining contact between the tool and the wet coating to work the wet coating.

In examples, the method may comprise detecting a parameter that varies according to a distance between the tool head and the wet coating in the stroke direction. The detected parameter may be a force, a position, a displacement, or a power current of the actuator, as described below.

In examples, the detected parameter may be a displacement of the tool relative to the tool head in the stroke direction. The detected parameter may be a position of the tool relative to the tool head. In other examples, the detected parameter may be a biasing force applied to the tool by the biasing module.

In examples, the detected parameter may be a force applied by the actuator when moving the arm across the surface. For example, the detected parameter may be a power current of the actuator moving the arm. The power current of the actuator may increase or decrease according to the degree of interaction between the tool and the wet coating, so the power current of the actuator is indicative of the position of the tool relative to the wet coating. That is, if the tool is closer to the surface then it will be moving more wet coating as the arm moves, and the actuator moving the arm will have a higher power current.

In examples, the tool head may comprise a motor arranged to rotate the tool in contact with the wet coating. In such examples, the detected parameter may be a torque applied by the motor. A higher power current or torque may be indicative of a greater contact force between the wet coating and the tool.

In some examples, the biasing module may have an adjustable stiffness. In such examples, the method may comprise adjusting the stiffness of the biasing module as the tool head moves across the surface.

In examples, the method may comprise adjusting the tool path based on the detected parameter as the arm moves across the surface. For example, if the detected parameter indicates that the tool is encountering high resistance in a particular area, the tool path may be configured to reduce the force applied.

In examples, the method may comprise moving the tool in the stroke direction relative to the wet coating based on the detected parameter. For example, the method may comprise moving the arm and/or moving the tool relative to the tool head.

In examples, the method may comprise maintaining a predetermined force between the tool and the wet coating. The predetermined force may be a predetermined range of forces.

In examples, the method may comprise scanning the surface and generating the tool path based on scan data from the scanning process. The scanning may comprise use of a LiDAR scanner to obtain point cloud data of the surface, either before or after application of the wet coating to the surface. The tool path can be configured to move the tool over the surface (in contact with the wet coating) so that the tool works all or substantially all of the wet coating on the surface.

In some examples, the apparatus can be positioned based on the scan data from the scanning process. The apparatus can be positioned, based on the scan data, such that the arm is able to position the tool to work the wet coating. The tool path may comprise a position of the apparatus relative to the surface, as well as a position of the arm relative to the surface. The tool path may include moving the apparatus relative to the surface, for example to work a wet coating on another part of the surface.

Viewed from a further aspect, the present invention provides a method of working a wet coating, such as render material, on a surface, the method comprising:
scanning the surface to generate scan data indicative of an approximate position of the surface;
locating the apparatus described above adjacent to the surface having a wet coating applied thereon;
generating a tool path for the apparatus based on the scan data; and
operating the apparatus to move the tool to work the wet coating on the surface;
wherein during operation of the apparatus, the tool moves relative to the arm to accommodate variations in the position of the surface and/or wet coating.

The tool moves relative to the arm by the compliance module. The biasing module may bias the tool towards the surface. Accordingly, the compliance module allows the tool to move to accommodate surface variations not picked up in the scan data. Advantageously, the scan data can be used to position the apparatus adjacent to the surface and to configure the tool path such that the arm moves the tool over the surface within a first tolerance range, while the compliance module allows the tool to move relative to the arm to accommodate surface variations within a second tolerance range less than the first tolerance range. Accordingly, the scan data can be used to automate working of the wet coating, while the compliance module ensures that the tool is able to accommodate smaller surface variations.

In examples, the method comprises detecting a parameter that varies according to a distance between the tool head and the wet coating in the stroke direction. The detected parameter may be a force, a position, a displacement, or a power current of the actuator, as described below.

In examples, the method comprises moving the tool based on the detected parameter. The tool may be moved by moving the arm in the stroke direction, and/or by moving the tool relative to the arm.

Viewed from a further aspect, the present invention provides a compliance module as described above.

Viewed from a further aspect, the present invention provides a compliance module comprising:
a body attachable to an arm,
a connector configured to receive a tool for working a wet coating on a surface, and
a biasing module biased to urge the connector away from the body in a stroke direction such that the tool is movable relative to the body as the tool is moved across the surface in contact with the wet coating.

In examples, the compliance module may further comprise a sensor configured to detect a parameter that varies according to a distance between the body and the wet coating in the stroke direction. The detected parameter may be a force, a position, a displacement, or a power current of the actuator, as described below.

In examples, the sensor may be configured to measure a displacement of the tool relative to the tool head in the stroke direction. The sensor may be a displacement sensor arranged to measure a position of the tool relative to the body of the compliance module. In other examples, the sensor may be a force sensor, for example a load cell, arranged to detect the biasing force applied to the tool by the biasing module.

In examples, the tool head may comprise a motor arranged to rotate the tool in contact with the wet coating. In such examples, the sensor may comprise a torque sensor configured to measure a power current of the motor and/or a torque applied by the motor. A higher power current or torque may be indicative of a greater contact force between the wet coating and the tool.

In examples, the biasing module comprises a spring. The spring is arranged to urge the tool in the stroke direction, i.e., towards the surface. The spring may be a compression spring. The biasing module may additionally comprise a damper.

In examples, the biasing module has an adjustable stiffness. The stiffness may be manually adjusted. Different stiffnesses may be provided for different wet coating materials and/or different desired finishes. A higher stiffness may correspond to a smoother finish of the wet coating.

### BRIEF DESCRIPTION OF THE DRAWINGS

Embodiments of the invention are further described hereinafter with reference to the accompanying drawings, in which:

FIG. 1 illustrates a perspective view of an exemplary gantry;

FIGS. 2 & 3 illustrate close-up views of an exemplary tool head;

FIGS. 4 to 7 illustrates exemplary tool heads connected to an arm;

FIG. 8 is a schematic illustration of an exemplary tool path for working a wet coating on a surface;

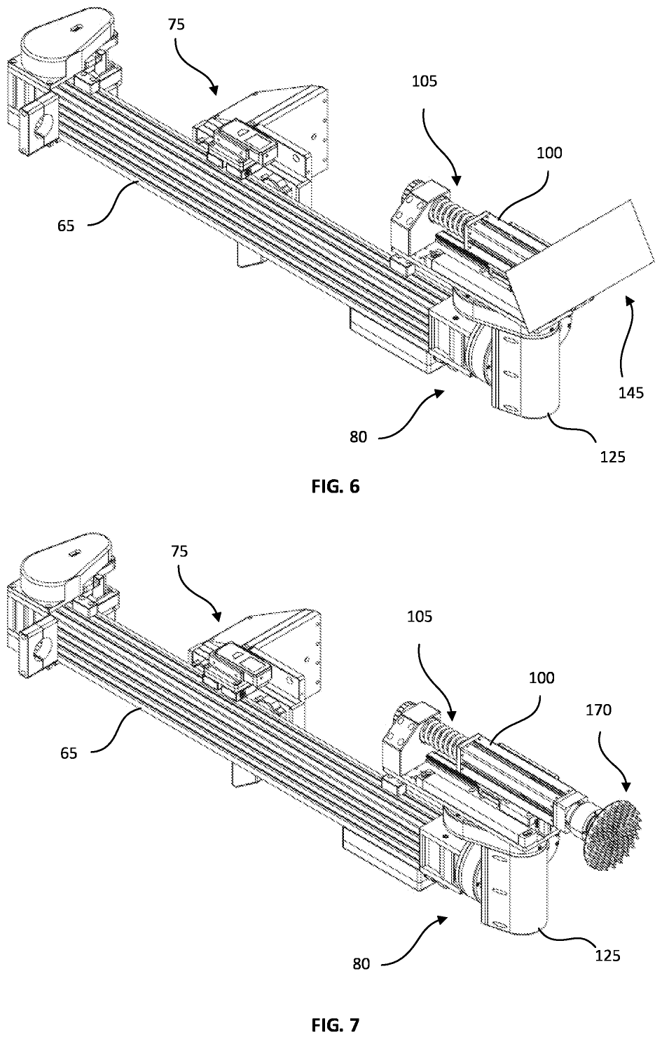

FIGS. 9 & 10 illustrate an apparatus working a wet coating of a substrate in an off-site location;

FIG. 11 illustrates an exemplary apparatus working a wet coating of a substrate applied to a building; and

FIG. 12 illustrates an exemplary process.

### DETAILED DESCRIPTION

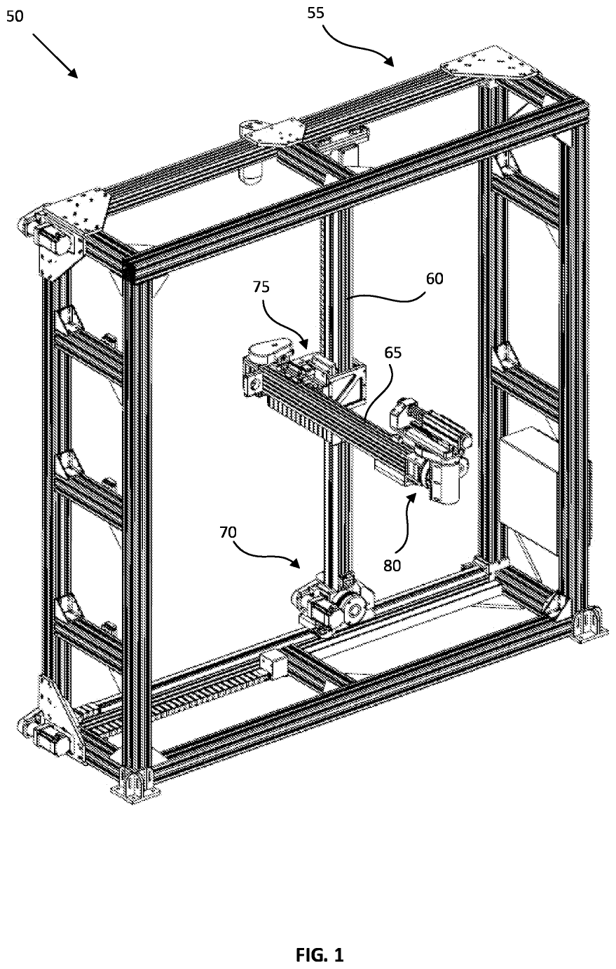

FIG. 1 illustrates an exemplary gantry 50 comprising a frame 55, first 60 and second 65 arms, a first actuator 70, a second actuator 75 and a tool head 80. The first actuator 70 is arranged to travel along the frame 55 and move the first arm 60 relative to the frame 55. The second actuator 75 is arranged to travel along the first arm 60 and also to move the second arm 65 relative to the frame 55. In the illustrated gantry 50, the first actuator 70 moves in a lateral direction relative to the frame 55, and the second actuator 75 moves the second arm 65 vertically relative to the frame 55 and also forwards and backwards along a linear axis 140 relative to the frame 55. The second actuator 75 is arranged to move the second arm 65 in a plane defined by the frame 55, however, it would be apparent this was not essential. While the second actuator 75 is shown as being arranged to move the second arm 65 in two directions, it would be apparent that this was not essential, and that separate actuators could be used to move the second arm 65 in the vertical and forward/backward directions. The first 70 and second 75 actuators are therefore able to move the tool head 80 across a surface of a building or similar substrate as well as towards and away from the surface in a perpendicular direction.

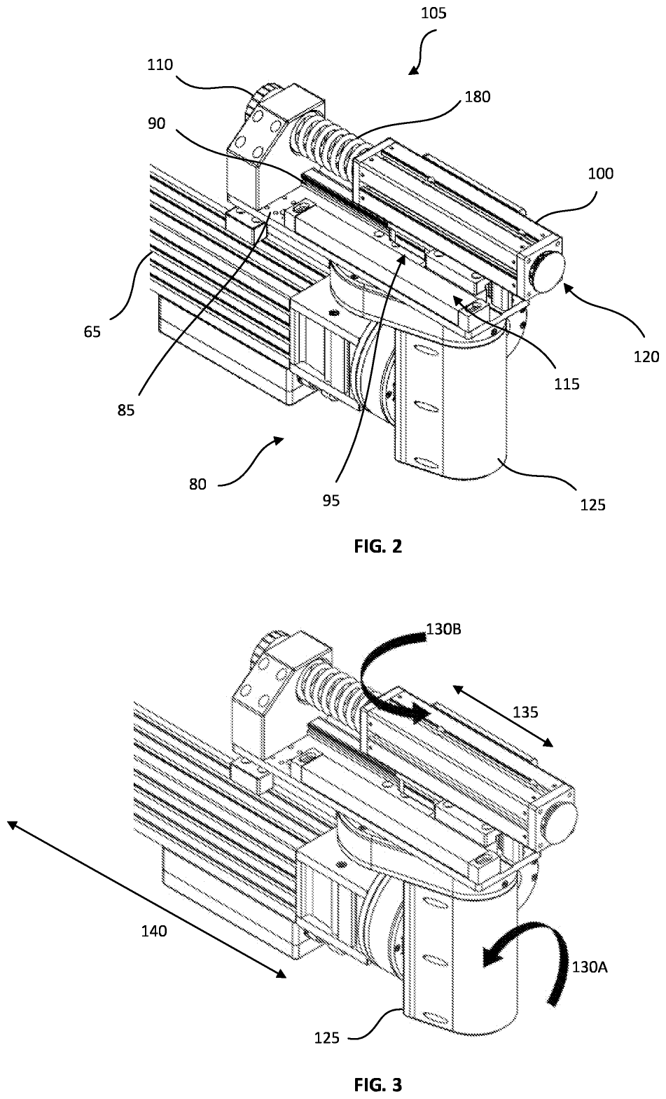

As shown in FIG. 2, the tool head 80 is connected to the second arm 65 using a two-axis rotary head 125. This arrangement is particularly advantageous as, in addition to the three degrees of freedom provided by the three axes of linear translation, two further axes of motion 130A, 130B are provided to the tool head 80, thus providing the tool head 80 with five degrees of freedom. With such range of motion, it is possible to maintain any desired angle between the surface and a tool attached to the tool head 80. Thus, the present apparatus is able to work a wide range of surface contours, for example non-planar or curved surfaces or objects in the surface, such as around a bay window or corners, while applying a consistent level of force to a wet coating layer 32, for example a wet render coating or insulation material, on the surface 34. With the additional rotation's degrees of freedom, the tool head 80 is able to move across the surface while maintaining the tool in a perpendicular orientation relative to the surface. This is particularly advantageous, as it avoids the need to manually setup and ensure the robot is aligned to the worksurface. While the rotary head 125 is shown having rotary axes 130A, 130B that are perpendicular to one another, it would be apparent that this was not essential and that the two rotary axes 130A, 130B may be provided at any angle relative to one another, including in a parallel arrangement.

The tool head 80 also includes a housing 85 secured to the two-axis rotary head 125. The tool head 80 also includes a compliance module 105 to provide compliance between the housing 85 and the connector head 100. The compliance module 105 comprises a linear rail 90 that is mounted to the housing 85. A connector head 100 having an end 120 for receiving a tool is secured to the linear rail 90 via a carriage 95. By securing the connector head 100 to the linear rail 90, the connector 100 is movable relative to the housing 85 and constrained to a particular direction 135 (referred herein as a stroke direction). For example, when a force is applied to the tool attached to the connector head 100, this will result in displacement of the connector head 100 relative to the housing 95 due to the compliance module 105, in particular the linear rail 90 and carriage 95. A biasing module 180, in this example a spring, is arranged to urge the tool towards the surface 32. This provides a convenient way of accounting for surface variations in the surface. The end 120 includes a connector for connecting one or more tools to the compliance module 105. This advantageously allows a single tool head to be used with many tools. Alternatively, or additionally, the connector head 100 may be releasably secured to the linear rail 90. Thus, the same tool head 80 can be used with multiple different connector heads 100, each being able to connect to one or more tools as described herein.

In some examples, the tool head 80 is moved over the surface along a tool path based on a surface scan of the building, for example using a LIDAR sensor or a depth sensor. The scan of the surface can generate scan data indicative of an approximate position of the surface which is used to plan a suitable tool path 34 for the tool head 80. The scan data may not be accurate enough to detect smaller surface variations, for example less than about +/−25 mm, so as the tool is moved across the surface the compliance module 105 permits movement of the tool relative to the wet coating to provide consistent working of the wet material and generate a substantially level surface of the wet coating.

The illustrated biasing module 180 is shown as a spring in the Figures, but it would be apparent that other passive components, such as elastomeric members and/or dampers may be used in place or in addition to the spring.

A linear encoder 115 is also secured to the housing 85. The linear encoder 95 is able to measure the translation of the connector head 100, which is used to provide feedback to a controller (not shown) operatively coupled to the tool head 80. This feedback can be used to adjust a tool path 34 on which the tool is following, so that the tool is kept in contact with the wet coating 32 on the surface 30 being worked. Where there are small variations in the surface of the building, the deformation of the biasing module 180 in the stroke direction 135 is sufficient to ensure the tool remains in contact with the wet coating 32 and that the wet coating 32 is worked at a desired level. The speed of the tool across the surface can also be adjusted depending on the feedback provided by the linear encoder 115 and or any force sensors present in the compliance module 105 as described below. It would be apparent that a linear encoder 115 is merely provided as one example of a sensor configured to detect a parameter that varies across the surface, and that one or more additional sensors may be provided to detect one or more associated parameters that vary across the surface as described below. It would be apparent that the sensor may be secured to any of the connector head 100, the compliance module 105, or the housing 85. Similarly, the sensor data may be processed by an on-board controller of the gantry 50, or transmitted to a remote device for processing. The remote device may then transmit instructions to the controller to move the tool head 80 based on the sensed parameter.

The translation of the connector head 100 is directly related to the deformation of the biasing module 180, and therefore the measured translation can be used to derive the force applied by the tool to the wet coating, which can in turn be used to ensure a consistent force is being applied to the wet coating 32. The amount of force applied may be within a range forces depending on the requirements, such as the desired thickness of the finished render layer.

In some cases the second actuator 75 can be operated to move the tool head 80 towards or away from the surface along the linear axis 140 to ensure the desired contact is maintained to compliment the movement of the connector head 100 due to the compliance module 105. Such a case may be when the displacement of the connector head 100 is above a pre-determined threshold. In addition, or alternatively to the second actuator 75, the tool head 80 may include a tool actuator (not shown) to move the tool towards or away from the surface. The tool actuator may be part of the connector head 100 or the compliance module 105, or connected anywhere between the compliance module 105 and the tool to provide the additional correction of the tool head position. Preferably, the tool actuator is provided between the compliance module 105 and the arm 65.

While, accounting for surface variations that are above a threshold, for example the maximum travel of the biasing module 180, could necessitate active movement of the tool head 80, it would be apparent the tool path the tool head is following could be actively controlled based on the data from the linear encoder 115 at any level of displacement of the compliance module 105 to maintain a desired force. While the stroke direction 135 is shown as being substantially parallel to the linear axis 140, it would be apparent this was not essential. Similarly, while the stroke direction 135 is shown as being perpendicular to the surface 34 being worked, it would be apparent this was also not essential and the stroke direction 135 may be angled with respect to the surface 34. In particular, the stroke direction 135 may be any direction in which the biasing module 180 urges the connector head 100 (and tool) towards the surface, such that the connector head 100 (and tool) is displaceable in a direction away from the surface 34. The tool experiences a reaction force, for example a reaction force normal to the surface 34, and frictional forces, typically parallel to the surface, as the tool moves across the surface 34. Therefore, in some examples the compliance module 105 may be oriented such that the stroke direction 135 is parallel to the resultant force vector of the normal force and the frictional force, which may be at an angle to the surface as the tool moves across the surface.

The stiffness of the biasing module 180 is also preferably adjustable, for example manually adjustable using a dial 110, or other user input, as shown in the Figures, or electronically by the controller. The stiffness of the biasing module 180 may be controlled by the controller based on the feedback provided by the linear encoder 115.

In other examples, a power current of the actuator 70 that moves the tool head 80 across the surface may be detected. The power current is indicative of the force being applied by the tool head 80 on the wet coating, and so can provide feedback to the controller. The controller may be configured to adjust operation of the apparatus based on the detected power current. For example, a high power current may indicate that the tool head 80 should be spaced further from the surface, and the actuator 70 or actuator (not shown) on the tool head 80 may be operated to move the tool away from the surface.

The functionality of the tool head 80 described above may be used in conjunction with any of the robots described below. The connector head 100 is preferably releasably secured to linear rail 90. This allows the same gantry 50 to be used with different tools depending on the specific work to be performed on the surface 34. The tool head may also have a motor, for example a brushless DC motor, for applying a torque to rotate the tool connected to the connector head 100. The current drawn by the motor may also be used to provide feedback to the controller to adjust the position of the position or speed of the tool. The controller is configured to operate the actuators 70, 75 to move the tool along the tool path. The controller may calculate the tool path, for example based on sensor data, or the controller may receive data indicative of the tool path from a remote device (not shown). Where present, the controller may also provide active control of the tool based on feedback from the linear encoder 115 and the any force/torque sensors present.

Thus, the present gantry 50 is able to apply, shape and finish wet materials onto building surfaces or to finish a 3D printed structure. Wet materials include render, paint or plaster material, a coating material (e.g. a sprayable mineral wool such as Coatwool), insulation material (e.g. polyurethane). The wet material can be applied onto substrates, such as cast concrete wall or a steel structure. As will be described below, the gantry 50 may be deployed on-site (e.g. to process wet materials on a building) or off-site (e.g. at a factory to process pre-fabricated walls).

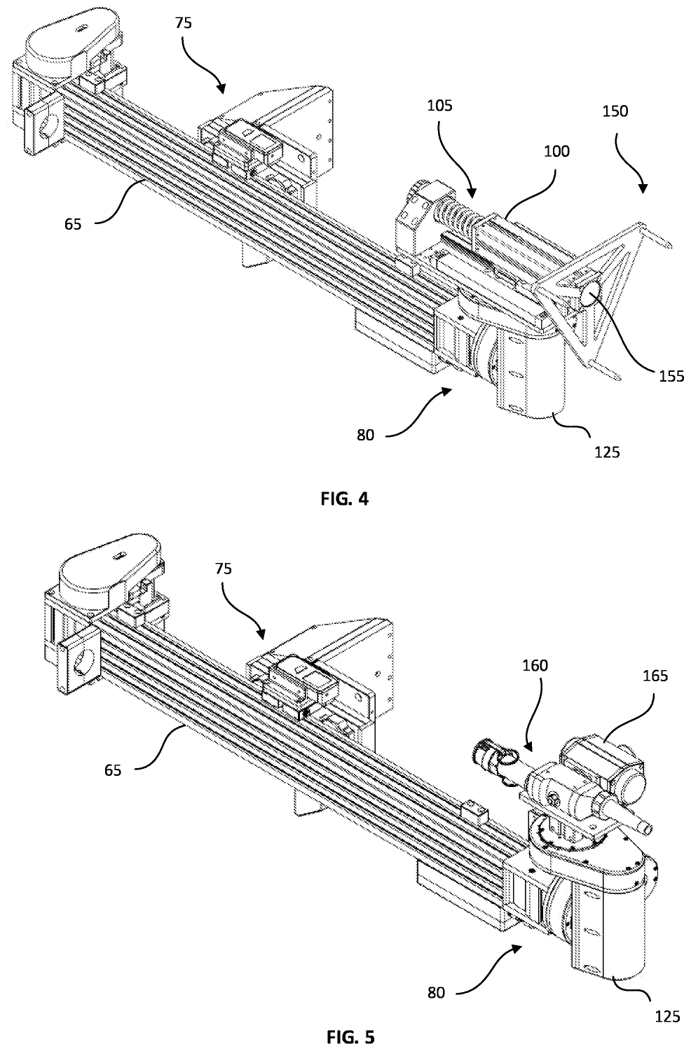

FIG. 4 illustrates an exemplary apparatus in the form of a ‘pick and place’ robot end actuator. The tool head 80 for this robot includes a gripping head 150 having a backplate and a series of spikes extending from the backplate to pierce a board of insulation material, in order to grip the insulation material. The connector head 100 of this robot may include a pneumatic piston 155 to push the insulation board away from the gripping head 150 and into position against a wall. The robot can then position the insulation material as desired by operating the first 70 and second 75 actuators accordingly. Once the insulation board is in the desired position, the tool head 80 is pressed against the surface, which causes a displacement of the connector head 100, and the pneumatic piston 155 can be actuated while the board is pressed against the surface, so the board remains in position as the tool head 80 is retracted from the board. Or the second arm 65 can be actuated by actuator 75 to press the board against the surface. This can be repeated for several insulation boards, for example to cover the wall of a building that is to be insulated. It would be apparent that means for providing insulation boards to the robot for placing could be in the form of a user manually providing the boards, or a separate device providing the insulation boards in a suitable manner for the gripping head 150 to pick and place.

FIG. 5 illustrates an exemplary apparatus in the form of a rendering robot end actuator. The tool head 80 for this robot includes a nozzle 160 for extruding render onto the surface 34, for example the surface of the underlying wall if no insulation boards are provided, or onto a surface of the insulation boards. The tool head 80 also includes a pneumatic piston 165 for controlling flow of render through the nozzle 160. The nozzle 160 is preferably a ball valve controlled nozzle. The nozzle 160 can be controlled by the controller to follow a tool path 34 to ensure render material covers the desired surfaces. The rendering robot can be used to apply one, two or more layers of render onto the surface of the insulating boards or of the underlying substrate. It would be apparent that the application of different layers of render could be achieved using either using a second rendering robot or using the same robot. It would be apparent that the second layer of render may be applied to a different thickness than the first layer, and may also be applied using a different tool path to that used to apply the first layer of render. The nozzle 160 is typically coupled to a source of wet coating material by a tether, with the material being pumped to the nozzle 160 for projection or extrusion onto the surface. The nozzle 160 is preferably moved across the surface at a distance of up to 10 centimetres and the render is extruded from the nozzle 160 onto the surface to form a wet coating on the surface.

FIG. 6 illustrates an exemplary apparatus in the form of a smoothing robot end actuator. The tool head 80 of this robot includes a trowel 145 for smoothing wet render 32 on the surface 30. The movement of the trowel 145 follows a tool path 34. This tool path 34 may be offset 36 from the underlying surface 30 such that the trowel 145 is in contact with the wet render 32 only. As the trowel 145 moves across the surface 30 smoothing the wet render 32, variations in the surface 30 are accounted for by a compliance module 105 configured in a passive configuration and/or an active configuration as described above. The trowel 145 smooths the render and applies a consistent force against the render to ensure the wet render adheres to the underlying substrate surface 30 properly. Thus, the smoothing robot ensures the finished render 32 is sufficiently smooth and well-adhered with a consistent thickness and/or surface level across the entire surface 30. The tool path for the smoothing robot may cross the surface 30 and smooth the render one or more times following the same of different patterns.

In some cases, a robot which combines the rendering functionality and the smoothing functionality may be used to apply render and smooth the render at the same time. In this case, there is no need to make small adjustments to the position of the nozzle 160 as its tolerance is typically much greater than the surface variations of the surface being rendered. For example, if a laser scan of a building is accurate to +/−12.5 mm then the tool path 34 can be within 25 mm of the surface. The nozzle 160 can be adjusted to avoid collisions with the surface using this error band, but as the nozzle typically applies the wet coating to the surface, for example spraying paint, extruding plaster, render or other coatings over a distance of at least 2 to 10 cm, the variability in the building surface can be easily accounted for while still ensuring the render reaches the substrate. Alternatively, the nozzle can be adjusted to extrude material directly onto the surface and may be between 0 cm and 5 cm from the surface.

By way of example, the rendering robot can apply layers of render in thicknesses of 8 mm (e.g. in the range of 5 to 25 mm). As 8 mm is typically smaller than the sensing capability of a LIDAR scanner or depth sensor and the variation in the wall, the robot is programmed to scan the surface it is presented with and plan the tool path 34 based on the scan data, accounting for the accuracy of the sensors. This is advantageous as such a process does not require very accurate sensors or calibration and a detailed setup procedure to ensure the tool is working the wet coating 32 correctly, as the final adjustment of the tool is achieved by the displacement provided by the compliance module 105. This feedback can be enhanced using sensor data (e.g., from linear encoder 115) to provide feedback. This feedback can be used to adjust the control routine to actively control the tool path as the tool moves across the surface 30.

FIG. 7 illustrates an exemplary apparatus in the form of a scratching robot end actuator. The tool head 80 of this robot includes a scratching tool 170 for scratching the partially dried render. The scratching process forms grooves in the render so a top coat that is subsequently applied is better able to grip to the scratched coat of render. By utilising the compliance module 105 of the present application, the tool path of the scratching tool 170 can be set such that the scratching tool 170 only scratches the render and not the underlying surface. The connector head 100 of the scratching robot includes a brushless DC motor to rotate the scratching tool 170 to form the scratched layer. A torque applied by the brushless DC motor, or a power current drawn by the brushless DC motor, may be sensed to determine a force between the scratching tool 170 and the wet coating. The sensed torque or power current may be used to adjust the tool path or position of the scratching tool 170. However, while a rotating scratching tool 170 is described, it would be apparent this was not essential and other scratching tools may be used which can form the desired grooves using linear motion. It would be apparent that once the scratched layer has been formed, a top coat of render can be applied using the rendering robot described above following the same or a different tool path to the one used to apply the scratched render coat.

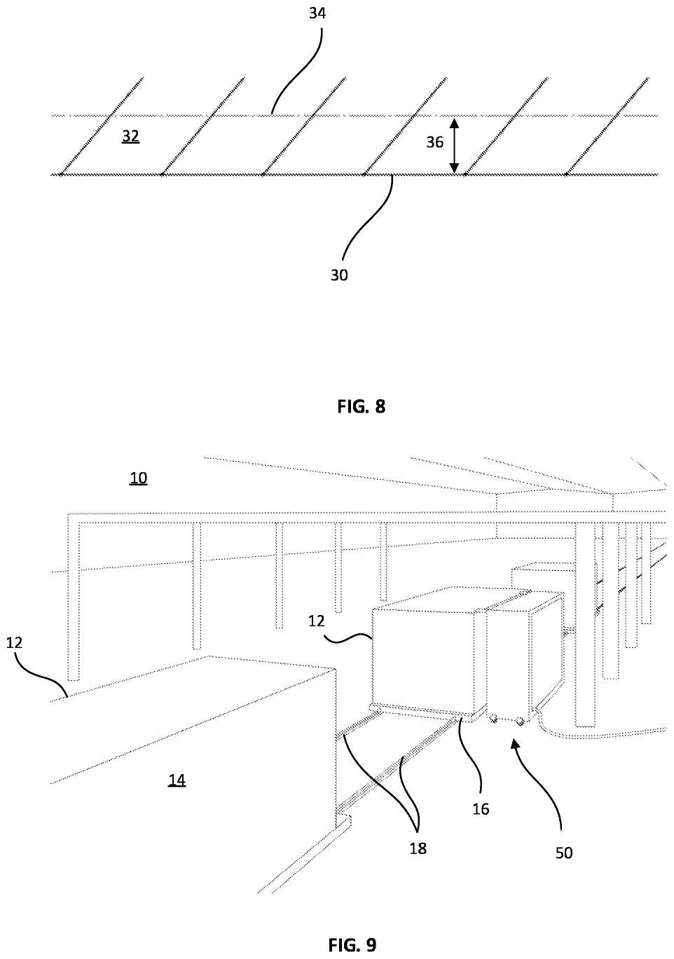

As illustrated in FIGS. 9 and 10, the gantry 50 can perform one or more of the process described above to pre-fabricated building elements 12, such as wall panels, in an off-site location, such as in a factory 10. The factory 10 can include one or more of the above-described gantries 50 configured to perform one or more of the steps described above, for example in an assembly line. Thus, after the surface 14 of each building element has been worked on by a gantry 50, the building element can be moved on to the next station (not shown) for processing, for example by locating the building element on a platform 16 mounted on rails 18. Alternatively, or in addition to this, one gantry 50 may have one or more different tool heads 80 configured to perform one or more of the processes described above. Securing elements 52 may be provided on the gantry 50 to secure the gantry 50 to the building element 12 to maintain the relative position between the gantry 50 and the building element 12 when a wet coating on the surface 14 is being worked on.

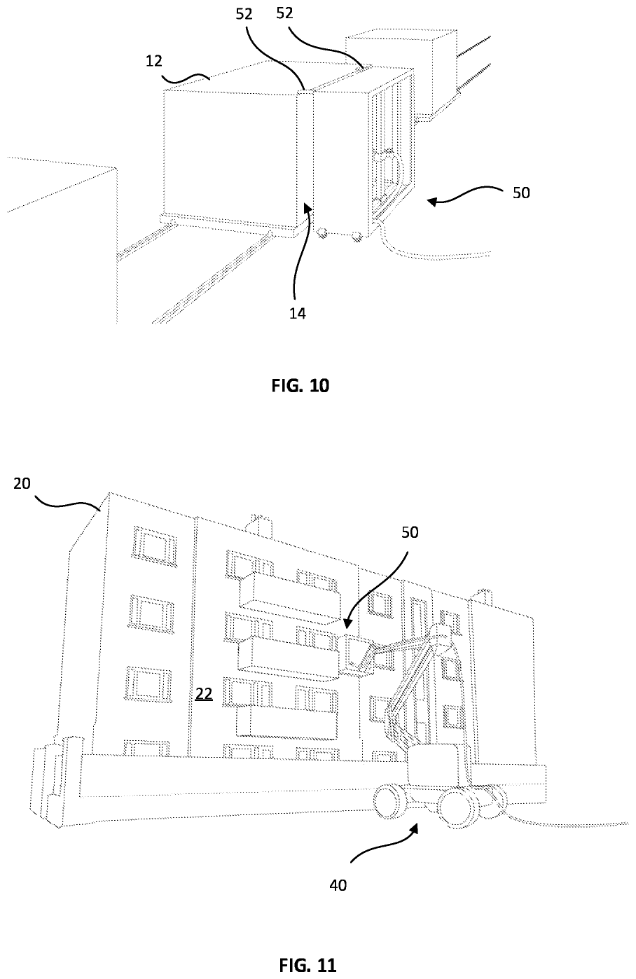

As shown in FIG. 11, the gantry 50 can alternatively be mounted to a mobile vehicle 40 and positioned against a surface 22 of a building 20. The present apparatus is capable of accounting for the variations in the building surface 22 using a tool head 80 configured in an active and/or passive setup as described above. This ensures the finished render coating 32 is sufficiently smooth and also has a consistent thickness and/or surface across the entire surface 22, which helps to improve the weather proofing, thermal properties and/or the aesthetics of the building 20. As shown in FIG. 11, the gantry 50 is tethered to a source of material that is remote from the gantry 50, e.g. on the ground in the example of FIG. 11.

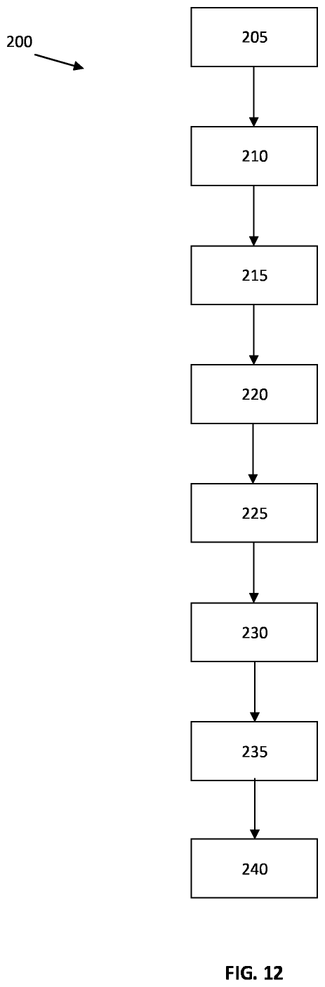

FIG. 12 illustrates an exemplary process 200. The process 200 includes scanning 205 a surface 22 of a substrate, such as a building 20, to obtain scan data indicative of the surface 22. The scan data may then be processed 210 to determine a computational model of the building 20, e.g. dimensions or properties of a surface 22 or contour of the building 20. From the scan data and/or determined model, one or more tool paths 34 can be calculated 215 for one or more different tools to work the surface 22 of the building 20. Once a tool path has been calculated, insulation boards can be positioned 220 against the surface 22, for example using the pick and place robot described above. One or more layers of render can then be applied 225, for example, using the rendering robot described above. Once the render has been applied, the render can be smoothed and then scratched according to a smoothing step 230 and a scratching step 235, for example using the smoothing and scratching robots described above. After the render has been scratched a top coat of render can then be applied 240, for example using the rendering robot described above. It would be apparent that not all of these processes were essential to the method. For example, a robot may only perform one or more of the above processes, as other robots or persons may have performed the remaining steps.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

1. An apparatus for working a wet coating applied to a surface, the apparatus comprising:
an actuator adapted to move an arm across the surface having the wet coating applied thereon;
a controller configured to move the arm across the surface along a tool path; and
a tool head mounted to the arm, the tool head includes a compliance module and a tool mounted to the compliance module such that the tool is movable in a stroke direction towards the surface relative to the arm, wherein the compliance module includes a biasing module adapted to urge the tool in the stroke direction to maintain contact with the wet coating to work the wet coating as the arm moves across the surface.

2. An apparatus according to claim 1, further comprising a sensor configured to detect a parameter that varies according to a distance between the arm and the wet coating in the stroke direction.

3. An apparatus according to claim 2, wherein the sensor is configured to measure a displacement of the tool relative to the tool head in the stroke direction.

4. An apparatus according to claim 2, wherein the sensor is configured to detect a force applied by the actuator when moving the arm across the surface.

5. An apparatus according to claim 2, wherein the controller is configured to adjust the tool path based on the detected parameter as the arm moves across the surface.

6. An apparatus according to claim 2, further comprising a second actuator arranged to move the arm towards or away from the surface, wherein the controller is configured to control the second actuator based on the detected parameter.

7. An apparatus according to claim 2, wherein the tool head includes a tool actuator adapted to move the compliance module in the stroke direction, and wherein the controller is configured to control the tool actuator based on the detected parameter.

8. An apparatus according to claim 2, wherein the controller is configured to move the tool across the surface while maintaining a pre-determined force between the tool and the wet coating based on the detected parameter.

9. An apparatus according to claim 1, wherein the tool includes either one of a scraper or a trowel.

10. An apparatus according to claim 1, wherein the controller is configured to position the tool in a substantially perpendicular orientation relative to the surface as the arm moves across the surface.

11. An apparatus according to claim 1, further comprising a rotary actuator adapted to rotate the compliance module and tool relative to the arm about a first axis perpendicular to the stroke direction.

12. An apparatus according to claim 11, further comprising a second rotary actuator adapted to rotate the compliance module and tool relative to the arm about a second axis parallel to the stroke direction.

13. A method of working a wet coating on a surface, the method comprising:
locating an apparatus according to claim 1 adjacent a surface having a wet coating applied thereon, and
moving the tool head across the surface along a tool path while maintaining contact between the tool and the wet coating to work the wet coating.

14. A method according to claim 13, further comprising detecting a parameter that varies according to a distance between the tool head and the wet coating in the stroke direction.

15. A method according to claim 14, wherein the detected parameter is a displacement of the tool relative to the compliance module.

16. A method according to claim 14, wherein the detected parameter is a power current of the actuator moving the arm.

17. A method according to claim 14, further comprising adjusting the tool path based on the detected parameter.

18. A method according to claim 14, further comprising moving the tool in the stroke direction relative to the wet coating based on the detected parameter.

19. A method according to claim 18, wherein moving the tool in the stroke direction includes moving the arm.

20. A method according to claim 18, wherein moving the tool in the stroke direction includes moving the tool relative to the tool head.

21. A method according to claim 14, further comprising maintaining a predetermined force between the tool and the wet coating.

22. A method according to claim 13, further comprising scanning the surface and generating the tool path based on scan data from the scanning process.

23. A method of working a wet coating on a surface, the method comprising:
scanning the surface to generate scan data indicative of an approximate position of the surface;
locating an apparatus according to claim 1 adjacent to the surface having the wet coating applied thereon;
generating a tool path for the apparatus based on the scan data; and
operating the apparatus to move the tool to work the wet coating on the surface;
wherein during operation of the apparatus, the tool moves relative to the arm to accommodate variations in the position of the surface and/or wet coating.

24. A method according to claim 23, further comprising detecting a parameter that varies according to a distance between the tool head and the wet coating in the stroke direction.

25. A method according to claim 24, further comprising moving the tool based on the detected parameter.
